(19) United States
(12) Patent Application Publication
(10) Pub. No.: US 2025/0202000 A1
(43) Pub. Date: Jun. 19, 2025

(54) Battery-Based Electrical System, Electrical Battery Pack and Battery-Based Electrical Apparatus

(71) Applicant: Andreas Stihl AG & Co. KG, Waiblingen (DE)

(72) Inventors: Christian UHLMANN, Uttenreuth (DE); Daniel Sauerteig, Kernen im Remstal (DE)

(21) Appl. No.: 18/988,050

(22) Filed: Dec. 19, 2024

(30) Foreign Application Priority Data
Dec. 19, 2023 (DE) 102023 135806. 5

(51) Int. Cl. H01M 50/213; H01M 10/04; H01M 10/42; H01M 10/44

(52) U.S. Cl. CPC H01M 50/213; H01M 10/0431; H01M 10/425; H01M 10/441; H01M 2220/30

(57) ABSTRACT

A battery-based electrical system, includes: an interchangeable battery pack for storing electrical energy, and a battery-based electrical apparatus that is detachably electrically connectable to the interchangeable battery pack. The battery pack has a number of substantially cylindrical electrical battery cells, wherein at least one of the electrical battery cells has an electrical battery cell impedance, a value of the battery cell impedance when an electrical AC current at an AC frequency of 1 kHz is applied being less than 10 mΩ, in particular less than 5 mΩ, quite particularly less than or equal to 3 mΩ, when the electrical state of charge of the battery cell is 50% and when the temperature of the battery cell is 20° C. to 25° C. The battery-based electrical system has an electronic starting current limiting device for, in particular reversibly, limiting an electrical starting current flowing between the battery pack and the battery-based apparatus.

### CROSS REFERENCE TO RELATED APPLICATION

This application claims priority under 35 U.S.C. § 119 from German Patent Application No. 102023135806.5, filed Dec. 19, 2023, the entire disclosure of which is herein expressly incorporated by reference.

### BACKGROUND AND SUMMARY

The invention relates to a battery-based electrical system and to an electrical battery pack for a battery-based electrical system of this kind. The invention also relates to a battery-based electrical apparatus for a battery-based electrical system of this kind.

An object of the present invention is to provide a battery-based electrical system and also an electrical battery pack for a battery-based electrical system of this kind and a battery-based electrical apparatus for a battery-based electrical system of this kind that, in particular each, have improved properties.

This object is achieved by the subjects of the independent patent claims. Preferred embodiments are covered by the dependent patent claims.

A battery-based electrical system according to the invention comprises an interchangeable, in particular electrical, battery pack for storing electrical energy. The battery-based electrical system also comprises a battery-based electrical apparatus that is detachably electrically connectable to the interchangeable battery pack. The battery pack comprises a number of substantially cylindrical electrical battery cells. Practically, the battery cells are designed for storing electrical energy. At least one of the electrical battery cells, in particular each of the electrical battery cells, has an electrical battery cell impedance, a value of the battery cell impedance when an electrical AC current at an AC frequency of 1 kHz is applied being less than 10 mΩ (milliohms) when the electrical state of charge (SOC) of the battery cell is 50% and when the temperature of the battery cell is 20° C. to 25° C. In particular, a value of the battery cell impedance when an electrical AC current is applied and at an AC frequency of 1 kHz is less than 5 mΩ, quite particularly less than or equal to 3 mΩ, when the electrical state of charge of the battery cell is 50% and when the temperature of the battery cell is 20° C. to 25° C. In particular, only a real part, in particular and not the imaginary part, of the battery cell impedance is considered for the value of the battery cell impedance. The battery-based system additionally comprises an, in particular active, electronic starting current limiting device. The starting current limiting device is used for, in particular reversibly, limiting an electrical starting current flowing between the battery pack and the battery-based apparatus. Given an, in particular desirably low, battery cell impedance of this kind, a relatively large electrical starting current can arise, which is why the provision of the electronic starting current limiting device can prove particularly advantageous. The starting current limiting device may be particularly easily accessible, in particular independently of the battery cells, in particular for maintenance and/or repair purposes, which can result in advantages from the point of view of repairability and/or maintainability, in particular against the background of sustainability.

“Substantially cylindrical”, in the present context, can take account of the presence of a chamfer and—alternatively or additionally—a rounded portion at an, in particular circumferential and/or edge-like, transition between an end face of the respective substantially cylindrical battery cell and an outer surface of the respective battery cell. Alternatively or additionally, “substantially cylindrical” can take account of the presence of an unevenness and/or shaping of at least one of the end faces of the respective battery cell. “Substantially cylindrical” can take account of a rounded shape, in particular of the outer surface.

“Substantially cylindrical”, in the present context, can relate, in particular alternatively or additionally, to the shape of a general cylinder. It is thus contemplated for the respective substantially cylindrical battery cell to have, by way of example, a prismatic, in particular parallelepipedal, shape. Preferably, the respective substantially cylindrical battery cell has a substantially circular-cylindrical shape. The respective substantially circular-cylindrical battery cell can be referred to synonymously as a “round battery cell”. In particular, the respective substantially cylindrical battery cell is not a pouch cell.

The term “configured” can be used synonymously for the term “designed”.

The term “encompasses” or “has” can be used synonymously for the term “comprises”.

The phrase “and alsoalternatively or additionally—” may be equivalently replaceable with “and/or”.

“Controlling”, in the present context, can comprise or be “open-loop control” and/or “closed-loop control”.

Preferably, the state of charge of 50% can be ascertained as follows: the respective battery cell can be charged to a predetermined, in particular manufacturer-defined, nominal voltage, the nominal voltage corresponding to the state of charge of 50%. Alternatively or additionally, the respective battery cell can initially be fully electrically discharged or charged so as then to charge or discharge precisely 50% of the capacity of the battery cell, with the result that the state of charge of 50% is reached and/or set. It goes without saying that other and/or combined methods of ascertainment may be appropriate.

Preferably, the battery cell impedance can be ascertained as follows: an electrical AC current at a fixed AC frequency of 1 kHz can be impressed on the respective battery cell, the AC voltage response of the battery cell that results from the impression being measured. “Impress” can be understood as synonymous with “apply” here. The battery cell impedance, in particular its value, is obtained as an AC resistance (z=u/i) from the ratio of the measured AC voltage u to the AC current i.

Preferably, the starting current limiting device is designed exclusively for limiting the starting current that flows for a period, by way of example, directly after the battery-based apparatus has been switched on and alsoalternatively or additionally—directly after the battery pack has been electrically connected to the battery-based apparatus. The period can be dependent on various parameters. The period may be predetermined and also—alternatively or additionally—temperature-dependent and also—alternatively or additionally—age-dependent and/or—alternatively or additionally—dependent on the state of charge of the battery pack. In particular, no further current limiting is performed by means of the starting current limiting device when the period has elapsed. The starting current limiting device may be designed for limiting the electrical current only temporarily.

Preferably, the value of the electrical battery cell impedance of the battery cells when an electrical AC current at an AC frequency of 1 kHz is applied is greater than 0.1 mΩ, in particular greater than 0.5 mΩ, in particular greater than 1 mΩ, quite particularly greater than 2 mΩ, when the electrical state of charge is 50% and when the temperature is 20° C. to 25° C.

Preferably, the number of battery cells is 1. The number of battery cells may be a plurality. Preferably, the number is 1 to 500, in particular 3 to 200.

Preferably, at least two and/or all of the battery cells are, in particular in respect of the battery cell impedance and also—alternatively or additionally—geometrically, of identical design and/or specification.

In a refinement of the invention, the at least one battery cell is in the form of an electrical multi-tab cell having at least one, in particular wound, multi-tab electrode. Alternatively or additionally, the at least one battery cell is in the form of an electrical tabless cell having at least one, in particular wound, tabless electrode.

Preferably, the tabless cell, in particular in the form of a round tabless cell, is designed in accordance with US 2020/0144676 A1. The tabless cell can be referred to synonymously as an “endless tab cell” having at least one endless tab electrode and also—alternatively or additionally—as an “earless tab cell” having at least one earless tab electrode and also—alternatively or additionally—as an “ear-free cell” having at least one ear-free electrode and also—alternatively or additionally—as a “continuous tab cell” having at least one continuous tab electrode and also—alternatively or additionally—as a “full tab cell” having at least one full tab electrode.

Preferably, battery cells can generally comprise two wound electrodes, in particular separated from one another, in particular in the manner of a sandwich, by means of a separator of the respective battery cell. In a battery cell that is in particular not in the form of a tabless cell and/or not in the form of a multi-tab cell, one of the axial ends of at least one of the electrodes can have in particular integral connecting sections (tabs) arranged occasionally at intervals from one another for electrically connecting this electrode to one of two cell contact sections of the relevant battery cell. The connecting sections arranged occasionally at intervals from one another can form bottlenecks for an electrical current flowing between the relevant electrode and the relevant cell contact section, which can result in a relatively high battery cell impedance for such battery cells. In particular, the two cell contact sections have opposite electrical polarities in a state of the battery cell in which it is charged with electrical energy. In the state of the battery cell in which it is charged with electrical energy, there may thus be a voltage on the two cell contact sections. A respective cell contact section may be formed by a disc-shaped and/or cap-shaped contact element of the battery cell.

Preferably, the tabless cell, in particular in contrast to a battery cell that is not in the form of a tabless cell, can comprise at least one, in particular wound, tabless electrode, one of the axial ends of the tabless electrode comprising only a single, in particular integral, connecting section, which also—alternatively or additionally—extends, in particular spirally, around a winding axis of the tabless electrode over an entire extent of the tabless electrode, for electrically connecting this tabless electrode to the relevant instance of the two cell contact sections. The tabless electrode thus in particular does not have multiple connecting sections.

Preferably—in particular in contrast to the tabless electrode of the tabless cell—a multi-tab electrode of a multi-tab cell can have a multiplicity of, in particular directly successively arranged, connecting sections that are in particular each radially bent in such a way that two adjacent instances of the connecting sections touch one another and also—alternatively or additionally—overlap one another.

It goes without saying that, preferably, hybrid forms of battery cells are contemplated in which, by way of example, the two electrodes are associated with different electrode types. It may sometimes even be contemplated for a single instance of the electrodes to be associated with different electrode types, for example if its axial ends are in different forms.

In a further refinement of the invention, the battery pack comprises the electronic starting current limiting device, in particular integrally. Alternatively or additionally, the battery-based apparatus comprises the electronic starting current limiting device, in particular integrally. The starting current limiting device may thus be part of the battery pack and/or of the battery-based apparatus. Devices in the form of an “assembly” may be, in particular inseparably, attached to one another and also—alternatively or additionally—housed by means of a common housing. “Inseparable” can mean “not intended for separation” and/or “not non-destructively separable”. In particular, “inseparable” can be understood as an antonym of “detachable”.

Preferably, it is contemplated, in particular as an alternative to the refinement mentioned in the preceding paragraph of the description, for the electronic starting current limiting device to be detachably mounted on the battery pack and also—alternatively or additionally—on the battery-based apparatus, in particular in the manner of an adapter and also—alternatively or additionally—so as to be universally usable. The battery pack and the battery-based apparatus may thus be electrically and mechanically, in particular detachably, connected by means of the starting current limiting device.

In a further refinement of the invention, the battery-based electrical apparatus is in the form of an electrical processing apparatus that can be operated by means of electrical energy from the battery pack. Alternatively or additionally, the battery-based apparatus is in the form of an electrical charger for charging the interchangeable battery pack with electrical energy to be stored.

Preferably, the battery-based apparatus in the form of a processing apparatus is ground-supported and/or handheld, in particular carried by hand, and/or carried on the back and/or a garden, forest, ground and/or construction processing apparatus. The processing apparatus may be in handheld form, that is to say in particular a direction of processing of the processing apparatus can be adjusted relative to a workpiece currently being processed by means of the processing apparatus by a user's hand that is holding the processing apparatus. In particular, the processing apparatus may be a saw, in particular a chainsaw, or a pole pruner, or hedge clippers, or a hedge cutter, or an undergrowth cutter or a lopper, a chop saw or a blower, or a leaf blower, or a suction apparatus, or a leaf vacuum, or a cleaning apparatus, or a high-pressure cleaner, or a sweeper, or a sweeper roller, or a sweeping brush, or a lawnmower or a grass cutter, or a brushcutter, or a scarifier. Additionally or alternatively, the processing apparatus can comprise a processing tool and/or an, in particular electrical, drive motor, in particular for driving the processing tool. The drive motor may be able to be supplied with electrical energy from the battery pack, in particular in order to provide drive power for the processing tool.

Preferably, the battery-based apparatus in the form of a charger has a mains connection for electrical connection to an electrical energy source, for example to an electrical supply grid. The charger can be used to charge the received battery pack with electrical energy from the energy source. The charger can comprise an electronic charge controller.

It goes without saying that the battery-based apparatus in the form of a processing apparatus can have a mains connection for electrical connection to an electrical energy source, for example to an electrical supply grid, in order to charge the battery pack with electrical energy from the electrical energy source. In this respect, the battery-based apparatus may be in the form of both a processing apparatus and a charger in a dual function.

Preferably, the battery-based apparatus comprises an electrical device that is electrically connected or connectable to the starting current limiting device. If the battery-based apparatus is in the form of a processing apparatus, the electrical device can comprise the electrical drive motor for driving the processing tool. If the battery-based apparatus is in the form of a charger, the electrical device can comprise the electronic charge controller.

In a further refinement of the invention, the electronic starting current limiting device comprises at least one electronic semiconductor switch, in particular a MOSFET, for in particular automatically and also—alternatively or additionally—reversibly, controlledly interrupting an electrical current, in particular the starting current, flowing between the battery pack and the battery-based apparatus.

Preferably, the battery pack and the battery-based apparatus comprise complementary connecting interfaces for, in particular detachably, mechanically and for, in particular detachably, electrically connecting the battery pack to the battery-based apparatus. Preferably, the battery-based apparatus has a receiving device for interchangeably receiving and accordingly electrically connecting the battery pack to the battery-based apparatus, the receiving device comprising or forming the connecting interface of the battery-based apparatus.

In a further refinement of the invention, the battery pack and the battery-based apparatus each have an electronic control device. The control devices are configured, in particular programmed, and also—alternatively or additionally—matched to one another, for identifying the battery pack and the battery-based apparatus to one another. The battery pack and the battery-based apparatus also each have complementary, in particular electrical, communication interfaces designed for communicatively connecting the control devices of the battery pack and of the battery-based apparatus to one another. The control devices can each comprise an electronic microprocessor device.

In a further refinement of the invention, the battery-based electrical system comprises an electrical negative path for electrically connecting the battery pack to the battery-based apparatus and an electrical positive path for electrically connecting the battery pack to the battery-based apparatus. The electrical starting current can flow, in particular successively, through the negative path and the positive path. In this scenario, the electronic starting current limiting device is arranged in the positive path and also—alternatively or additionally—in the negative path. The electronic starting current limiting device may thus be arranged both in the positive path and in the negative path—or the electronic starting current limiting device may be arranged only in the positive path or only in the negative path.

Preferably, the current limiting device may be arranged in an electrical connecting path of the battery pack, the electrical connecting path connecting at least two battery cells of the battery pack to one another.

Preferably, the connecting path can electrically connect at least two packets of battery cells to one another, the packets being in particular electrically connected in parallel or series by means of the connecting path. The battery cells associated with a packet may be electrically connected in series or parallel with one another within the packet.

In a further refinement of the invention, the battery cells each have an axial cell height and a cell diameter measured at right angles to the cell height. The cell diameter is 10 mm to 30 mm. Alternatively or additionally, the cell height is 40 mm to 78 mm.

An electrical battery pack according to the invention is provided for a battery-based electrical system according to the invention as described above. In particular, the electrical battery pack according to the invention is designed for use in the battery-based electrical system. The electrical battery pack comprises a number of electrical battery cells, wherein at least one, in particular each, of the electrical battery cells has an electrical battery cell impedance, a value of the battery cell impedance when an electrical AC current at an AC frequency of 1 kHz is applied being less than 10 mΩ, in particular less than 5 mΩ, quite particularly less than or equal to 3 mΩ, when the electrical state of charge of the battery cell is 50% and when the temperature of the battery cell is 20° C. to 25° C. The battery pack can comprise the electronic starting current limiting device for, in particular reversibly, limiting the electrical starting current.

In a refinement of the invention, the battery pack comprises an electronic control device that is configured, in particular programmed, for identifying the battery-based apparatus and also—alternatively or additionally—for revealing an identity of the battery pack. The battery pack in this scenario has a communication interface for communicatively connecting the electronic control device of the battery pack to an electronic control device of the battery-based apparatus by means of a complementary communication interface of the battery-based apparatus.

In a further refinement of the invention, the battery pack comprises the electronic starting current limiting device integrally.

Preferably, the at least one battery cell has no “current interrupt device (CID)”. In particular, a CID of this kind is, in particular integrally and/or non-removably, present as a current interrupt device in conventional round battery cells. The CID of conventional round battery cells is designed in particular for irreversibly limiting, in particular interrupting, the electrical current, i.e. tripping of the CID in order to limit the current a single time results in the CID losing its function and/or becoming irreversibly damaged. In particular, tripping of the, in particular inseparably, integrated CID in conventional round battery cells leads to the whole round battery cell becoming unusable and/or irreversibly damaged, with the result that the whole conventional battery cell then has to be replaced. In this respect, dispensing with an integrated CID can advantageously affect the sustainability of the battery pack, in particular because it means that the whole at least one battery cell does not have to be replaced after the electrical current has been limited. Dispensing with a CID of the battery cell can also advantageously affect an electrical battery cell impedance of the battery cell.

It is contemplated for the battery pack to be able to have at least or precisely one battery cell without a CID and at least or precisely one other battery cell with a CID. Preferably, however, none of the battery cells of the battery pack have a CID.

The current limiting device of the battery pack may be designed for limiting the whole and/or cross-cell electrical current flowing between the battery pack and the battery-based apparatus. At least some, in particular all, battery cells can thus share the current limiting device.

It is, in particular alternatively or additionally, contemplated for at least two of the battery cells of the battery pack to each have an associated current limiting device of the battery pack, the at least two current limiting devices being in particular separate from the battery cells. The current limiting devices may be controlled by means of an, in particular central, electronic control unit of the battery pack, in particular in order to limit the electrical current for each battery cell and/or across cells. In particular, each battery cell may have an associated current limiting device. The control unit can correspond to the control device of the battery pack and/or may be connected to the control device for control purposes.

A battery-based electrical apparatus according to the invention is provided for a battery-based electrical system according to the invention as described above. Preferably, the battery-based electrical apparatus according to the invention may thus be designed for use in the battery-based electrical system according to the invention. The battery-based electrical apparatus in this scenario comprises an electronic control device that is configured, in particular programmed, for revealing an identity of the battery-based apparatus and also—alternatively or additionally—for identifying the battery pack connected to the battery-based apparatus. The battery-based apparatus also has a communication interface for communicatively connecting the electronic control device of the battery-based apparatus to an electronic control device of the battery pack by means of a complementary communication interface of the battery pack.

In a refinement of the invention, the battery-based apparatus comprises the electronic starting current limiting device, in particular integrally.

It goes without saying that both the battery-based apparatus and the battery pack can each comprise an, in particular integrated, electronic starting current limiting device of their own, the starting current limiting devices in this case being able, in particular at least in part or only in part, to be redundant with respect to one another.

It is also, in particular alternatively or additionally, contemplated for the battery-based apparatus and the battery pack to each comprise only a segment of the starting current limiting device, the segments being merged when the battery-based apparatus is detachably connected to the battery pack, in order to complete the starting current limiting device. In particular, a respective instance of the segments is not capable of limiting the starting current on its own.

Further advantages and features of the invention result from the claims and from the description below of preferred exemplary embodiments of the invention, which are shown with reference to the drawings. Identical reference signs refer to identical or similar or functionally identical components.

It goes without saying that the features mentioned above and those yet to be explained below can be used not only in the respectively indicated combination but also in other combinations or on their own without departing from the scope of the present invention.

### BRIEF DESCRIPTION OF THE DRAWINGS

FIG. 1 is a design plan for an embodiment of a battery-based electrical system according to the invention;

FIG. 2 is a design plan for a further embodiment of the battery-based electrical system according to the invention;

FIG. 3 is a schematic side view of an embodiment of an electrical battery pack according to the invention for the battery-based electrical system shown in FIG. 1 or FIG. 2;

FIG. 4 is a schematic perspective representation of a battery-based electrical apparatus in the form of an electrical charger for the battery-based electrical system shown in FIG. 1 or shown in FIG. 2; and

FIG. 5 is a schematic side view of a further embodiment of the battery-based system according to the invention with a battery-based apparatus in the form of a processing apparatus and with the battery pack, in particular as shown in FIG. 3.

### DETAILED DESCRIPTION OF THE DRAWINGS

A battery-based electrical system 1 comprises an interchangeable battery pack 2 for storing electrical energy. The battery-based electrical system 1 also comprises a battery-based electrical apparatus 3 that is detachably electrically connectable to the interchangeable battery pack 2. The battery pack 2 and the battery-based apparatus 3 in the present case comprise complementary connecting interfaces 12 for mechanically and electrically connecting the battery pack 2 to the battery-based apparatus 3.

By way of example, the battery-based apparatus 3 is in the form of an electrical processing apparatus 8, cf. FIG. 5. The processing apparatus 8 can be operated by means of electrical energy from the battery pack 2. Alternatively or additionally, the battery-based apparatus 3 is in the form of an electrical charger 9, cf. FIG. 4. The electrical charger 9 may be designed for charging the interchangeable battery pack 2 with electrical energy to be stored.

In accordance with FIG. 5, the battery-based apparatus 3 in the form of a processing apparatus 8 is in the form of a motor-driven chainsaw. The processing apparatus 8 can comprise an electric drive motor that is designed for driving a processing tool of the processing apparatus 8. The processing tool in the present case is a saw chain. The drive motor may be suppliable with electrical energy from the battery pack 2 in order to provide drive power for the processing tool.

The battery-based apparatus 3 in the form of the charger 9 can have a mains connection for electrical connection to an electrical energy source, for example to an electrical supply grid. The charger 9 can be used to charge the battery pack 2 with electrical energy from the energy source. The charger 9 can comprise an electronic charge controller.

It goes without saying that the battery-based apparatus 3 in the form of a processing apparatus 8 can have a mains connection—not shown in FIG. 5—for electrical connection to an electrical energy source, for example to an electrical supply grid, in order to charge the battery pack 2 with electrical energy from the electrical energy source. In this respect, the battery-based apparatus 3 may be in the form of both a processing apparatus 8 and a charger 9 in a dual function.

The battery-based apparatus 3 can comprise an electrical device 17 that is electrically connected or connectable to the starting current limiting device 4. If the battery-based apparatus 3 is in the form of a processing device 8, the device 17 can comprise the electric drive motor for driving the processing tool. If the battery-based apparatus 3 is in the form of a charger 9, the device 17 can comprise the electronic charge controller.

The battery pack 2 comprises a number of substantially cylindrical electrical battery cells 5. The battery cells 5 may each be designed for storing electrical energy. At least one, in the present case each, of the electrical battery cells 5 has an electrical battery cell impedance, a value, in particular only the real part, of the battery cell impedance when an electrical AC current at an AC frequency of 1 kHz is applied being less than 10 mΩ, in particular less than 5 mΩ, in the present case less than or equal to 3 mΩ, when the electrical state of charge of the battery cell 5 is 50% and when the temperature of the battery cell 5 is 20° C. to 25° C. The value of the battery cell impedance, for each battery cell 5, can be greater than 0.1 mΩ, in particular greater than 0.5 mΩ, in particular greater than 1 mΩ, in the present case greater than 2 mΩ.

The number of battery cells 5 may be 1. The number of battery cells 5 may—as in the present case—be a plurality. Preferably, the number is 1 to 500, in particular 3 to 200, in the present case 6.

By way of example, at least two and/or all of the battery cells 5 are, in particular in respect of the battery cell impedance and/or geometrically, of identical design and/or specification.

The battery cells 5 in the present case each have an axial cell height and a cell diameter measured at right angles to the cell height. The cell diameter is for example 10 mm to 30 mm. Alternatively or additionally, the cell height is 40 mm to 78 mm.

The battery-based electrical system 1 comprises an electronic starting current limiting device 4 for limiting an electrical starting current flowing between the battery pack 2 and the battery-based apparatus 3. By way of example, the electronic starting current limiting device 4 is designed for reversibly limiting the starting current.

The starting current limiting device 4 may be designed exclusively for limiting the starting current that flows for a specific period, by way of example, directly after the battery-based apparatus 3 has been switched on and/or directly after the battery pack 2 has been electrically connected to the battery-based apparatus 3. The period can be dependent on various parameters. The period may be predetermined and/or temperature-dependent and/or age-dependent and/or dependent on a state of charge of the battery pack 2.

The at least one, for example each, of the battery cells 5 may be in the form of a multi-tab cell having at least one, for example wound, multi-tab electrode. Alternatively or additionally, the at least one, for example each, of the battery cells 5 may—as in the present case—be in the form of a tabless cell 6 having at least one, in the present case wound, tabless electrode 7.

The tabless electrode 7 of a respective instance of the tabless cells 6 is wound, for example. One of the axial ends of the tabless electrode 7 can comprise only a single, in particular integral, connecting section (tab), and/or a connecting section that extends around a winding axis of the tabless electrode 7 over an entire extent of the tabless electrode 7, for electrically connecting the tabless electrode 7 to an associated cell contact section of the tabless cell 6. The tabless electrode 7 thus in particular does not have multiple connecting sections. In contrast to the tabless electrode 7 of the tabless cell 6, a multi-tab electrode of a multi-tab cell can have a multiplicity of, in particular directly successively arranged, connecting sections that are in particular radially bent in such a way that two adjacent instances of the connecting sections touch one another and/or overlap. Hybrid forms of battery cells 5 are contemplated.

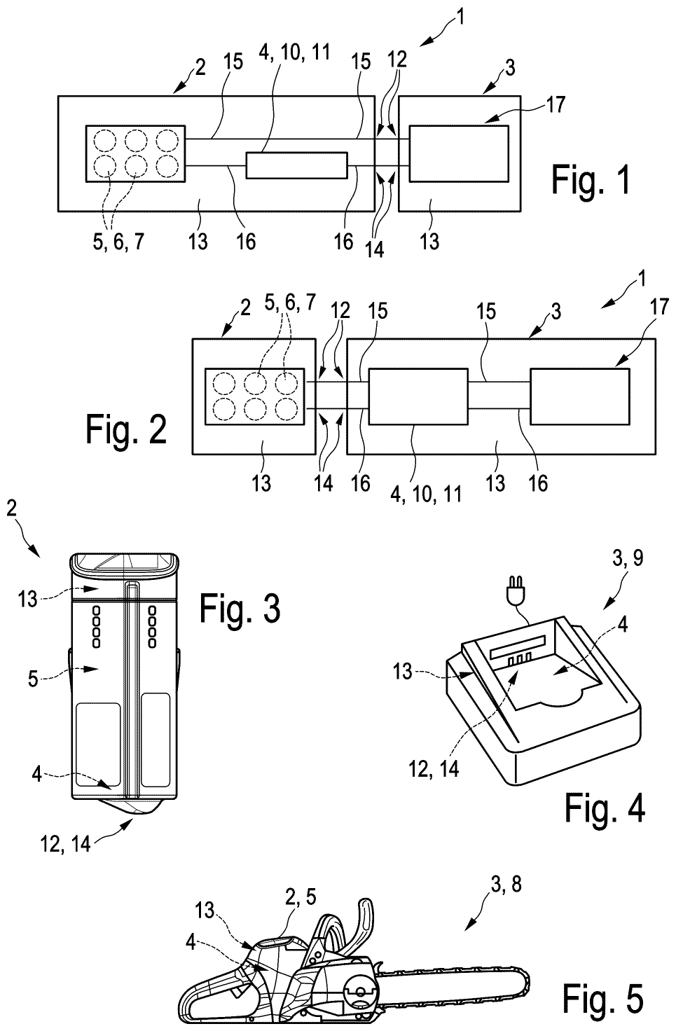

By way of example, the battery pack 2 comprises the electronic starting current limiting device 4, cf. FIGS. 1 and 3. Alternatively or additionally, the battery-based apparatus 3 can comprise the electronic starting current limiting device 4, cf. FIG. 2 and FIG. 4.

The starting current limiting device 4 may have been comprised by the battery pack 2 integrally, cf. FIG. 1. Alternatively or additionally, the starting current limiting device 4 may have been comprised by the battery-based apparatus 3 integrally, cf. FIG. 2. “Integral” devices may be, in particular inseparably, attached to one another and/or housed by means of a common housing.

It is contemplated, as an alternative to the embodiments shown, for the electronic starting current limiting device 4 to be detachably mounted on the battery pack 2 and/or on the battery-based apparatus 3, in particular in the manner of an adapter and/or so as to be universally usable. In this case, the starting current limiting device 4 may thus be mounted as a separate device between the battery pack 2 and the battery-based apparatus 3 in order to detachably electrically connect the battery pack 2 and the battery-based apparatus 3 to one another.

The electronic starting current limiting device 4 comprises at least one electronic semiconductor switch 10, for example. The electronic semiconductor switch 10 may be a MOSFET 11. The electronic semiconductor switch 10 can be used for, in particular automatically and/or reversibly, controlledly interrupting an electrical current, in particular the starting current, flowing between the battery pack 2 and the battery-based apparatus 3. The semiconductor switch 10 may be designed for connecting an electrical resistor element of the starting current limiting device 4.

By way of example, the battery pack 2 comprises an electronic control device 13. In the present case, the battery-based apparatus 3 also comprises an, in particular different, electronic control device 13. The battery pack 2 and the battery-based apparatus 3 also each comprise complementary communication interfaces 14 that are designed for communicatively connecting the control devices 13 of the battery pack 2 and of the battery-based apparatus 3 to one another. The control devices 13 can comprise an electronic microprocessor device.

The control devices 13 of the battery pack 2 and of the battery-based apparatus 3 are configured, in the present case programmed, and also—alternatively or additionally—matched to one another, for identifying the battery pack 2 and the battery-based apparatus 3 to one another, for example.

The electronic control device 13 of the battery pack 2 is configured, in particular programmed, for identifying the battery-based apparatus 3 and also—alternatively or additionally—for revealing an identity of the battery pack 2, for example. The communication interface 14 of the battery pack 2 may be designed for communicatively connecting the electronic control device 13 of the battery pack 2 to an electronic control device 13 of the battery-based apparatus 3 by means of a complementary communication interface 14 of the battery-based apparatus 3.

The electronic control device 13 of the battery-based apparatus 3 is configured, in particular programmed, for revealing an identity of the battery-based apparatus 3 and also—alternatively or additionally—for identifying the battery pack 2 connected to the battery-based apparatus 3, for example. The communication interface 14 of the battery-based apparatus 3 may be designed for communicatively connecting the electronic control device 13 of the battery-based apparatus 3 to the electronic control device 13 of the battery pack 2 by means of a complementary communication interface 14 of the battery pack 2.

The battery-based electrical system 1 has, for example, an electrical negative path 15 for electrically connecting the battery pack 2 to the battery-based apparatus 3. The battery-based system 1 in the present case also has an electrical positive path 16 for electrically connecting the battery pack 2 to the battery-based apparatus 3. In this scenario, the starting current limiting device 4 may be arranged in the positive path 16 and also—alternatively or additionally—in the negative path 15. In accordance with FIG. 1, the electronic starting current limiting device 4 is arranged exclusively in the positive path 16. By contrast, in accordance with FIG. 2, the starting current limiting device 4 is arranged both in the positive path 16 and in the negative path 15. It goes without saying that the starting current limiting device 4 may alternatively be arranged exclusively in the negative path 15.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A battery-based electrical system, comprising:
an interchangeable battery pack for storing electrical energy; and
a battery-based electrical apparatus that is detachably electrically connectable to the interchangeable battery pack,
wherein the battery pack comprises a number of substantially cylindrical electrical battery cells,
wherein at least one of the electrical battery cells has an electrical battery cell impedance, a value of the electrical battery cell impedance when an electrical AC current at an AC frequency of 1 kHz is applied being less than 10 mΩ, when the electrical state of charge of the battery cell is 50% and when the temperature of the battery cell is 20° C. to 25° C.; and
an electronic starting current limiting device for reversibly limiting an electrical starting current flowing between the battery pack and the battery-based apparatus.

2. The battery-based electrical system according to claim 1,
wherein the value of the electrical battery cell impedance when the electrical AC current at an AC frequency of 1 kHz is applied being less than 5 mΩ.

3. The battery-based electrical system according to claim 2,
wherein the value of the electrical battery cell impedance when an electrical AC current at an AC frequency of 1 kHz is applied being less than or equal to 3 mΩ.

4. The battery-based electrical system according to claim 1,
wherein the at least one battery cell is a multi-tab cell having at least one wound, multi-tab electrode and/or a tabless cell having at least one wound, tabless electrode.

5. The battery-based electrical system according to claim 1,
wherein the battery pack comprises the electronic starting current limiting device integrally, and/or
wherein the battery-based apparatus comprises the electronic starting current limiting device integrally.

6. The battery-based electrical system according to claim 1,
wherein the battery-based electrical apparatus is an electrical processing apparatus that is operatable via electrical energy from the battery pack, and/or
wherein the battery-based electrical apparatus is an electrical charger for charging the interchangeable battery pack with electrical energy to be stored.

7. The battery-based electrical system according to claim 1,
wherein the electronic starting current limiting device comprises at least one electronic semiconductor switch for automatically and/or reversibly, controllably interrupting an electrical current flowing between the battery pack and the battery-based apparatus.

8. The battery-based electrical system according to claim 7, wherein the semiconductor switch is a MOSFET, and the electrical current is the starting current.

9. The battery-based electrical system according to claim 1,
wherein the battery pack and the battery-based apparatus each comprise an electronic control device, the control devices being configured for identifying the battery pack and the battery-based apparatus to one another,
wherein the battery pack and the battery-based apparatus each comprise complementary communication interfaces for communicatively connecting the control devices of the battery pack and of the battery-based apparatus to one another.

10. The battery-based electrical system according to claim 1, further comprising:
an electrical negative path for electrically connecting the battery pack to the battery-based apparatus; and
an electrical positive path for electrically connecting the battery pack to the battery-based apparatus,
wherein the electronic starting current limiting device is arranged in the positive path and/or in the negative path.

11. The battery-based electrical system according to claim 1,
wherein the battery cells each have an axial cell height and a cell diameter measured at right angles to the axial cell height,
wherein the cell diameter is 10 mm to 30 mm and/or the axial cell height is 40 mm to 78 mm.

12. An electrical battery pack for a battery-based electrical system having a battery-based electrical apparatus that is detachably electrically connectable to the electrical battery pack,
the electrical battery pack comprising:
a number of electrical battery cells,
wherein at least one of the electrical battery cells has an electrical battery cell impedance, a value of the battery cell impedance when an electrical AC current at an AC frequency of 1 kHz is applied being less than 10 mΩ, when the electrical state of charge of the battery cell is 50% and when the temperature of the battery cell is 20° C. to 25° C.; and
an electronic starting current limiting device for reversibly limiting an electrical starting current that flows between the battery pack and the battery-based electrical apparatus.

13. The battery-based electrical system according to claim 12, wherein
the value of the battery cell impedance when the electrical AC current at an AC frequency of 1 kHz is applied is less than 5 mΩ.

14. The battery-based electrical system according to claim 13, wherein
the value of the battery cell impedance when the electrical AC current at an AC frequency of 1 kHz is applied is less than or equal to 3 mΩ.

15. The electrical battery pack according to claim 11, further comprising:
an electronic control device that is configured for identifying the battery-based apparatus and/or for revealing an identity of the battery pack; and
a communication interface for communicatively connecting the electronic control device of the battery pack to an electronic control device of the battery-based apparatus via a complementary communication interface of the battery-based apparatus.

16. The electrical battery pack according to claim 11,
wherein the electronic starting current limiting device integrated in the battery pack.

17. A battery-based electrical apparatus for a battery-based electrical system having an interchangeable battery pack for storing electrical energy and an electronic starting current limiting device for reversibly limiting an electrical starting current that flows between the battery pack and the battery-based electrical apparatus,
the battery-based electrical apparatus comprising:
an electronic control device that is configured for revealing an identity of the battery-based apparatus and/or for identifying the battery pack connectable to the battery-based apparatus; and
a communication interface for communicatively connecting the electronic control device of the battery-based apparatus to an electronic control device of the battery pack via a complementary communication interface of the battery pack.

18. The electrical battery pack according to claim 17,
wherein the battery-based apparatus comprises the electronic starting current limiting device integrally.
